(19) United States
(12) Patent Application Publication
(10) Pub. No.: US 2024/0252907 A1
(43) Pub. Date: Aug. 1, 2024

(54) METHOD AND EXERCISE/ACTIVITY MATCHING APPARATUS FOR MATCHING APPARATUS FOR MATCHING PARTNERS

(71) Applicant: Ryan Boisvert, Latham, NY (US)

(72) Inventor: Ryan Boisvert, Latham, NY (US)

(21) Appl. No.: 18/429,742

(22) Filed: Feb. 1, 2024

Related U.S. Application Data
(60) Provisional application No. 63/482,122, filed on Jan. 30, 2023.

(51) Int. Cl. A63B 71/06; G06Q 10/02; G06Q 50/34

(52) U.S. Cl. CPC A63B 71/0616; G06Q 10/02; G06Q 50/34

(57) ABSTRACT

A method of matching partners for an exercise/activity, the method comprising: inputting a request for a partner for the exercise/activity by a requestor; determining if a suitable partner for the exercise/activity exists based on at least one exercise/activity criteria; notifying the suitable partner that a determination of a possible match for the exercise/activity has been identified; accepting the match for the exercise/activity by the suitable partner; determining an exercise/activity location for the requestor and the suitable partner; confirming acceptance of the exercise/activity location for the requestor and the suitable partner; determining if the exercise/activity location is available, and reserving the exercise/activity location.

### TECHNICAL FIELD

The disclosure relates generally to a method and exercise or activity matching apparatus for matching partners. More particularly, the disclosure relates generally to a method and exercise or activity matching apparatus for matching partners in a competitive event and reserving a location for the competitive event.

### BACKGROUND

Maintaining one's health has become a large focus for many around the world. Exercise has become a significant element in getting and staying healthy. Many people are content to exercise alone or go to a gym to use equipment. However, there is another segment of the population that enjoys the company of others during exercise. Also, in that segment of population that enjoys the company of others during exercise, many people enjoy a competitive aspect of exercise.

Certain exercise activities, such as tennis, golf, squash, badminton, and the like were regarded as a simple leisure life for “high-income” persons who could afford those activities. Recently, however, public venues, parks, courts, and courses that anyone can access have been created. Thus, the population who enjoys formerly “exclusive” exercise activities has rapidly increased.

However, compared to the increasing demand, it may be difficult to reserve a venue. Even if a venue reservation is made, it also may be difficult to find suitable partner(s) for that exercise or activity in time. Here, suitable partner(s) for that exercise or activity means a partner with a similar skill set in that exercise activity. For example, in golf, a 3-handicap player may not find it enjoyable to play with a beginner, no more than a person starting to learn to play tennis would be comfortable with a person who can serve at 75 miles per hour or more.

Thus, as the difficulty to obtain a venue reservation increase, it may also be difficult to arrange for a suitable skill level for a partner if that exercise activity requires a partner. Accordingly, a situation may arise in which a partner with a significant difference in skill level is needed in order not to cancel the venue reservation. Moreover, depending on the activity, which, for example in golf, one can get matched up with other players who are either better or worse, can make playing uncomfortable. Accordingly, a system that can reserve a venue and match a person with a suitable partner can enhance the exercise activity.

### BRIEF DESCRIPTION

All aspects, examples and features mentioned below can be combined in any technically possible way.

An aspect of the disclosure provides a method of matching partners for an exercise/activity, the method including: inputting a request for a partner for the exercise/activity by a requestor; determining if a suitable partner for the exercise/activity exists based on at least one exercise/activity criteria; notifying the suitable partner that a determination of a possible match for the exercise/activity has been identified; accepting the match for the exercise/activity by the suitable partner; determining an exercise/activity location for the requestor and the suitable partner; confirming acceptance of the exercise/activity location for the requestor and the suitable partner; and determining if the exercise/activity location is available, and reserving the exercise/activity location.

Another aspect of the disclosure includes any of the preceding aspects, and further includes: the requestor and the suitable partner engage in the exercise/activity; and entering and storing results of the exercise/activity.

Another aspect of the disclosure includes any of the preceding aspects, and wherein if the exercise/activity location is not available, identify other exercise/activity locations for the requestor and the suitable partner.

Another aspect of the disclosure includes any of the preceding aspects, and wherein the at least one exercise/activity criteria includes at least one of: baseball, softball, football, soccer, basketball, volleyball, hockey, dodgeball, and combinations thereof.

Another aspect of the disclosure includes any of the preceding aspects, and wherein the at least one exercise/activity includes at least one of a recreational sport or exercise/activity, such as at least one of golf, tennis, racquetball, squash, cricket, pickleball, hiking, running, walking, frisbee, basketball, cycling, fencing, rowing, horseshoes, cornhole, badminton, bowling, skiing, and combinations thereof.

Another aspect of the disclosure includes any of the preceding aspects, and further comprising placing a wager on the result of the exercise/activity.

Another aspect of the disclosure includes any of the preceding aspects, and wherein the wager includes at least one of monetary, credits, gift cards, swag, and items that have value.

Another aspect of the disclosure includes any of the preceding aspects, and wherein the acceptance of the match for the exercise/activity by the suitable partner includes at least one consideration by at least one of the requestor and the suitable partner.

Another aspect of the disclosure includes any of the preceding aspects, and, wherein the at least one consideration by at least one of the requestor and the suitable partner includes items of value.

Another aspect of the disclosure includes any of the preceding aspects, and wherein entering results of the exercise/activity includes at least one of handicap integrity, etiquette, sportsmanship, overall experience, exercise/activity location quality, and combinations thereof.

Another aspect of the disclosure includes any of the preceding aspects, and wherein the requestor and the suitable partner include at least one of: a team, a group, an individual, business, locale, and combinations thereof.

An aspect of the disclosure provides a non-transitory computer readable storage medium storing one or more computer programs adapted to cause a processor based system to execute steps comprising of matching partners for an exercise/activity, the method including: inputting a request for a partner for the exercise/activity by a requestor; determining if a suitable partner for the exercise/activity exists based on at least one exercise/activity criteria; notifying the suitable partner that a determination of a possible match for the exercise/activity has been identified; accepting the match for the exercise/activity by the suitable partner; determining an exercise/activity location for the requestor and the suitable partner; confirming acceptance of the exercise/activity location for the requestor and the suitable partner; determining if the exercise/activity location is available, reserving the exercise/activity location; and recording results of the exercise/activity once the requestor and the suitable partner engage in the exercise/activity.

Another aspect of the disclosure includes any of the preceding aspects, and, wherein if the exercise/activity location is not available, identifying other exercise/activity locations for the requestor and the suitable partner.

Another aspect of the disclosure includes any of the preceding aspects, and wherein the at least one exercise/activity criteria includes at least one of: baseball, softball, football, soccer, basketball, volleyball, hockey, dodgeball, and combinations thereof.

Another aspect of the disclosure includes any of the preceding aspects, and wherein the at least one exercise/activity includes at least one of a recreational sport or exercise/activity, such as at least one of golf, tennis, racquetball, squash, cricket, pickleball, hiking, running, walking, frisbee, basketball, cycling, fencing, rowing, horseshoes, cornhole, badminton, bowling, skiing, and combinations thereof.

Another aspect of the disclosure includes any of the preceding aspects, and further comprising placing a wager on the result of the exercise/activity.

Another aspect of the disclosure includes any of the preceding aspects, and wherein the wager includes at least one of includes monetary, credits, gift cards, swag, and items that have value.

Another aspect of the disclosure includes any of the preceding aspects, and wherein the acceptance of the match for the exercise/activity by the suitable partner includes at least one consideration by at least one of the requestor and the suitable partner.

Another aspect of the disclosure includes any of the preceding aspects, and wherein the at least one consideration by at least one of the requestor and the suitable partner includes items of value.

Another aspect of the disclosure includes any of the preceding aspects, and wherein entering results of the exercise/activity includes at least one of handicap integrity, etiquette, sportsmanship, overall experience, exercise/activity location quality.

Another aspect of the disclosure includes any of the preceding aspects, and, wherein the requestor and the suitable partner include at least one of: a team, a group, and individual, business, exercise/activity location.

Two or more aspects described in this disclosure, including those described in this summary section, may be combined to form implementations not specifically described herein.

The details of one or more implementations are set forth in the accompanying drawings and the description below. Other features, objects and advantages will be exercise or activity matching apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure.

FIG. 1 illustrates a flow chart of a method for matching partners in an exercise/activity and reserving a location for the exercise/activity according to embodiments of the disclosure.

FIG. 2 depicts a computer system for implementing a method and apparatus for matching partners in an exercise/activity and reserving a location for the exercise/activity according to embodiments of the disclosure.

It is noted that the drawing(s) of the disclosure are not necessarily to scale. The drawing(s) are intended to depict only typical aspects of the disclosure and therefore should not be considered as limiting the scope of the disclosure. In the drawing(s), like numbering represents like elements between the drawings.

### DETAILED DESCRIPTION

As an initial matter, in order to clearly describe the subject matter of the current disclosure, it will become necessary to select certain terminology when referring to and describing relevant digital exercise or activity matching applications, systems, and methodology. To the extent possible, common industry terminology will be used and employed in a manner consistent with its accepted meaning. Unless otherwise stated, such terminology should be given a broad interpretation consistent with the context of the present exercise or activity matching application and the scope of the exercise or activity matching appended claims. Those of ordinary skill in the art will exercise or activity matching appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

An exercise or activity partner matching system, method and exercise or activity matching apparatus are disclosed. As used herein exercise/activity means any activity or exercise in which a partner, playing partner, opponent, companion, colleague, team, fellow participant in the exercise activity, and the like may be needed or desired. Further, the exercise or activity can include golf, tennis, racquetball, squash, cricket, pickleball, hiking, volleyball, running, walking, frisbee, basketball, cycling, fencing, rowing, horseshoes, cornhole, boxing, mixed martial arts, badminton, bowling, skiing, and other such exercises or activities. Other activities may also include, for example, video games (e.g., online video games). In such a case, users may access the application via their game console to find a partner at another location. A wager may be placed on the video game with the partner at the other location.

In the past, exercises or activities, such as but not limited to golf, were regarded as a simple leisure life for a certain class who could afford the exercises or activities. However, recently, public venues, parks, courts, and courses that anyone can access have been created. Thus, the population who enjoys formerly “exclusive” exercises or activities has rapidly increased.

However, with respect to the increasing demand, it may be difficult to reserve a certain venue. For example, court time for pickleball, tennis, and tee times at a golf course normally require reserving a time, days in advance. Even if a reservation is made, dependent on the exercises or activities, if the exercise or activity is an outdoor event, severe weather or excessive heat may make it undesirable or impossible to conduct the exercise or activity. Also, if you are a “solo” it may be difficult to find a suitable partner in time. As noted above, depending on the activity, for example in golf, one can get matched up with other players who are either much better or worse, which of course can make playing uncomfortable for everyone involved.

Depending on the difficulty of the reservation, a situation may arise in which any person, regardless of difference in skill, may be sought in order not to cancel the reservation. Accordingly, a system that can quickly identify and match a suitable partner, even at an additional cost, would enhance the exercise or activity.

The partner matching system, method and exercise or activity matching apparatus can be performed by a computing device. The partner matching system and method may be embodied as a system, method, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, exercise or activity matching apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, exercise or activity matching apparatus, or device. The computer-usable medium may include a propagated data signal with the computer-usable program code embodied therewith, either in baseband or as part of a carrier wave. The computer usable program code may be transmitted using any exercise or activity matching appropriate medium, including but not limited to wireless, wireline, optical fiber cable, RF, etc.

Computer program code for carrying out operations of the present disclosure may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, exercise or activity matching apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing exercise or activity matching apparatus to produce a machine, such that the instructions, which execute via the processor of the computer or other programmable data processing exercise or activity matching apparatus, create means for implementing the functions/acts specified in the flowchart and/or block diagram block or blocks.

These computer program instructions may also be stored in a computer-readable medium that can direct a computer or other programmable data processing exercise or activity matching apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing exercise or activity matching apparatus to cause a series of operational steps to be performed on the computer or other programmable exercise or activity matching apparatus to produce a computer implemented process such that the instructions which execute on the computer or other programmable exercise or activity matching apparatus provide processes for implementing the functions/acts specified in the flowchart and/or block diagram block or blocks.

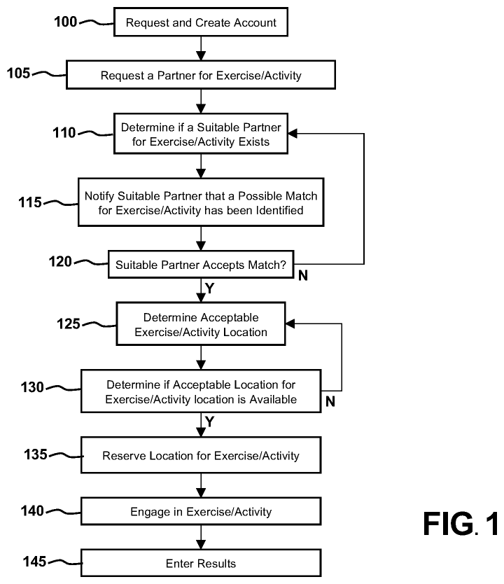

FIG. 1 is a flowchart illustrating an exercise or activity partner matching method according to embodiments of the invention.

With reference to FIG. 1, the method to be performed by the system will be described. In step 100, the method of matching partners for an exercise/activity includes inputting a request for an account and creating the account in a database. The request may be inputted, for example, via a computer, laptop, mobile phone, or in any other suitable manner, In step 105, a request for an exercise/activity is entered seeking a partner for the exercise/activity by a requestor.

Next, in step 110, the method determines if a suitable partner for the exercise/activity exists based on at least one exercise/activity criteria. The determination may be provided by a computing system (which may be implemented by a mobile device, remote server, or other suitable computing device) that receives the request and performs matching based, for example, on data from other users stored in a database or the like. In step 115, if a suitable partner for the exercise/activity exists based on at least one exercise/activity criteria, the suitable partner is notified a determination of a possible match for the exercise/activity has been identified. Notification may be provided via a text, phone message, email, or through an application.

In step 120, the suitable partner confirms and accepts the match for the exercise/activity. Once the match for the exercise/activity is accepted, an acceptable exercise/activity location is identified for the requestor and the suitable partner in step 125. In step 130, the exercise/activity location is confirmed as available. In step 135, a reservation is made for the exercise/activity location. If the acceptable exercise/activity location is not available, an alternative exercise/activity location is identified in step 125.

In step 140, the requestor and the suitable partner engage in the exercise/activity; and in step 145 results of the exercise/activity are entered (e.g., via a computer, mobile device, and/or the like).

According to the disclosure, exercise/activity means any activity or exercise in which a partner, playing partner, opponent, companion, colleague, team, fellow participant in the exercise activity, and the like may be needed or desired. The requestor and the suitable partner can include individuals; teams including school teams, amateur teams (AAU and the like), youth groups, and the like. The requestor and the suitable partner can be divisions of a company, competitive companies, fire/police groups, churches/mosques/synagogues, and the like, and other such groups.

As embodied by the disclosure, the exercise/activity can include a “competitive” sport or exercise/activity. For example, and not intending to limit the embodiments, the exercise/activity can include, team exercise/activity, such as but not limited to, baseball, softball, football, soccer, basketball, volleyball, hockey, dodgeball, combinations thereof, and any team exercise/activity now known or hereinafter developed.

In certain aspects of the disclosure, the exercise/activity can include a recreational sport or exercise/activity, such as at least one of golf, tennis, racquetball, squash, cricket, pickleball, hiking, running, walking, frisbee, basketball, cycling, fencing, rowing, horseshoes, cornhole, badminton, bowling, skiing, and other such exercises or activities now known or hereinafter developed.

In other aspects of the disclosure, the exercise/activity can include a contact exercise/activity, including but not limited to wrestling, boxing, judo, karate, and mixed martial arts and any such exercise/activity now known or hereinafter developed.

Aspects of the disclosure include the at least one exercise/activity criteria includes: team exercise/activity, such as but not limited to, baseball, softball, football, soccer, basketball, volleyball, hockey, dodgeball, and combinations thereof. Another aspect of the disclosure includes the at least one exercise/activity includes recreational sports and exercise/activity, including at least one of golf, tennis, racquetball, squash, cricket, pickleball, hiking, running, walking, frisbee, basketball, cycling, fencing, rowing, horseshoes, cornhole, badminton, bowling, skiing, and combinations thereof.

Another aspect of the disclosure includes placing a wager on the result of the exercise/activity. The wager includes items agreed upon by the requestor and the suitable partner, such as but not limited to, at least one of monetary, credits, gift cards, swag, and other items that have value to the requestor and the suitable partner.

A further aspect of the disclosure includes the acceptance of the match for the exercise/activity by the suitable partner includes at least one consideration by at least one of the requestor and the suitable partner. The at least one consideration by at least one of the requestor and the suitable partner includes other items that have value to the requestor and the suitable partner.

An additional aspect of the disclosure includes the requestor and the suitable partner include at least one of: a team, a group, and individual, business, exercise/activity location.

A further aspect of the disclosure includes wherein entering results of the exercise/activity that can include at least one of handicap integrity, etiquette, sportsmanship, overall experience, exercise/activity location quality, or other factors that may be pertinent to the exercise/activity.

The partner matching method disclosed herein may also include a method for rating the partner after completion of the exercise/activity. The rating may include, for example, providing a “star” rating (e.g., 5 stars—outstanding, 4 stars—exceeds expectations, 3 stars—meets expectations, 2 stars—below expectations, and 1 star—unacceptable, a scale from 1 to 10, with 10 being the best, etc.) for various aspects of the match and/or partner. Such aspects may include, for example, the quality of the match itself, the playing ability of the partner during the match, the behavior of the partner during the match, adherence to the rules of the exercise/activity during the match, and/or the like. Comments may also be provided to expand on the rating. For example, a user may indicate that the partner cheated or exhibited obnoxious behavior during the exercise/activity. In some cases, a user may award the partner a “favorite” status that indicates a preference to be matched again with that partner in the future.

A partner's rating may be available to all users. To this extent, a user may view a potential partner's rating prior to accepting a match for an exercise/activity with that partner. The rating method may also indicate that a user was previously matched with a particular partner for an exercise/activity and may indicate or provide access to data regarding the previous match. This may include, for example, the results of the exercise/activity in the previous match.

As embodied by the disclosure, a non-transitory computer readable storage medium storing one or more computer programs adapted to cause a processor-based system to execute steps comprising of matching partners for an exercise/activity can be provided. In accordance with this aspect, the method in the non-transitory computer readable storage medium storing one or more computer programs adapted to cause a processor based system to execute steps comprises inputting a request for a partner for the exercise/activity by a requestor; determining if a suitable partner for the exercise/activity exists based on at least one exercise/activity criteria; notifying the suitable partner that a determination of a possible match for the exercise/activity has been identified; accepting the match for the exercise/activity by the suitable partner; determining an exercise/activity location for the requestor and the suitable partner; confirming acceptance of the exercise/activity location for the requestor and the suitable partner; determining if the exercise/activity location is available, reserving the exercise/activity location; and entering results of the exercise/activity.

In accordance with certain aspects of the embodiments, the requestor and the suitable partner can access the exercise or activity matching application, as embodied by the disclosure (hereinafter “exercise or activity matching app”). If needed, the requestor and the suitable partner can download the exercise or activity matching app (e.g., from a computer, mobile phone, and the like) from any application store, such as, Google Play, iStore, and the like.

In accordance with certain aspects of the embodiments, once the exercise or activity matching app is downloaded, the requestor and the suitable partner is invited to enroll in the exercise or activity matching app. A requestor and the suitable partner will enroll by entering information about themselves, or their team/group. The information may include, but is not limited to, name, gender, age, location, username, password, exercise or activity interests, skill level in the one or more designated exercise or activity that the user wishes to utilize the exercise or activity matching app.

The requestor and the suitable partner may also enter a radius for which the requestor and the suitable partner are willing to travel to play an exercise or activity, in accordance with certain aspects of the embodiments. Other information that may be added can include sex or sexual orientation, physical information, height, weight, or particular data that may assist in planning and playing the exercise or activity.

For example, if a team exercise or activity such as volleyball, the requestor and the suitable partner may be asked by the exercise or activity matching app, if the requestor and the suitable partner is a middle hitter, outside hitter, libero, or general player. For other activities, the exercise or activity matching app may request information with respect to being left or right-handed, for example for softball or baseball.

Also, in accordance with certain aspects of the embodiments, other exercise or activity specific queries can be made and responded to if desired by the requestor and the suitable partner. For example, queries can be made about riding or walking if golf is a selected exercise or activity. Also, the exercise or activity matching app can ask for other bibliographical information, for example, schools attended, so a user can “match” with fellow alumni. Also, business interests can be queried and/or added by a user, so business connections may be made using the exercise or activity matching app.

Next in creating an account in step 105, the user (User A), now fully entered into the exercise or activity matching app, can seek out a match for the exercise or activity that they desire. User A requests a match by entering data, such as but not limited to, the exercise or activity type, skill level, specific location (field, course, arena, and the like) or general location (town, city, county, or region). The exercise or activity matching app will generate a listing of potential suitable partners for the exercise or activity match, based on User A's input and also inputs by potential suitable partners (User B).

Alternatively, User A may search the exercise or activity matching app for a particular potential suitable partner, User B. User A may look for a similar background or other data input that a requestor and/or suitable partner may have entered into the exercise or activity matching app to make an interesting match.

Once the user is fully signed up or enrolled in the exercise or activity matching exercise or activity matching app and suitable data (after a couple of matches), their past performance history will become available to opponents so that teams can do some scouting before accepting/declining the exercise or activity. For example, and not intending to limit the historical data, once the exercise or activity matching exercise or activity matching app generates a possible match, Team A will be able to see that the last 3 times Team B was a favorite by 2 or more strokes, they lost their matches. And vice-versa for Team B seeing that the last 3 times that Team A was an underdog of 2 or more strokes, they have 2 wins and 1 loss. This may encourage teams to accept matches or deter teams from accepting matches based on the performance history they are able to see about their potential opponent.

If the exercise or activity is golf, the app may also have specific selections to choose what type of golf game they would like to play:

a. Stroke play
b. Match play
c. 1 on 1, 2 on 2, etc.
d. Best Ball

Also, depending on the selected exercise or activity, the exercise or activity matching app, as embodied by the disclosure, can track a series of exercises or activities between requestor and/or suitable partner. In the example of golf, if the same foursome knows that they will be playing golf together all season long, they can tell the exercise or activity matching app they would like to play a 5-match series before wagers are finalized.

With respect to wagers, each party with an account on the exercise or activity matching app may be provided with an account to “store” items of value from the wagering. Wagered items can be transferred by the exercise or activity matching app upon entering results from the exercise or activity.

As embodied by the disclosure, the party with an account on the exercise or activity matching app may be college rivalries, clubs, church, or religious groups, fraternal/sororal groups, business sponsored groups, and any other such group.

According to one embodiment, the method comprising: determining whether the matching request user and the matching target user who have been matched play golf after the matching is made; and when it is determined that the golf play has been performed.

Advantages and features of the present invention, and methods for achieving them will become exercise or activity matching apparent with reference to the detailed description in conjunction with the accompanying drawings. However, it should be understood that the present invention is not limited to the embodiments presented below, but may be implemented in a variety of different forms, and includes all transformations, equivalents, and substitutes included in the spirit and scope of the present invention. The embodiments presented below are provided to complete the disclosure of the present invention, and to fully inform those of ordinary skill in the art to the scope of the present invention. In describing the present invention, if it is determined that a detailed description of a related known technology may obscure the gist of the present invention, the detailed description thereof will be omitted.

The terms used in the present exercise or activity matching application are only used to describe specific embodiments and are not intended to limit the present embodiments. The singular expression includes the plural expression unless the context clearly dictates otherwise. In the present exercise or activity matching application, terms such as “comprise” or “have” are intended to designate that a feature, number, step, operation, component, part, or combination thereof described in the specification exists, but one or more other features It should be understood that this does not preclude the existence or addition of numbers, steps, operations, components, parts, or combinations thereof. Terms such as first, second, etc. may be used to describe various elements, but the elements should not be limited by the terms. The above terms are used only for the purpose of distinguishing one component from another.

The methods according to the present invention may be implemented in the form of program instructions that can be executed by various computer and recorded in a computer-readable medium. The computer-readable medium may include program instructions, data files, data structures, and the like, alone or in combination. The program instructions recorded on the computer-readable medium may be specially designed and configured for the present invention or may be known and available to those skilled in the art of computer software.

Examples of computer-readable media include hardware devices specially configured to store and carry out program instructions, such as ROM, RAM, flash memory, and the like. Examples of program instructions include not only machine language codes such as those generated by a compiler 1 but also high-level language codes that can be executed by a computer using an interpreter or the like. The hardware device described above may be configured to operate as at least one software module to perform the operations of the present invention, and vice versa.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

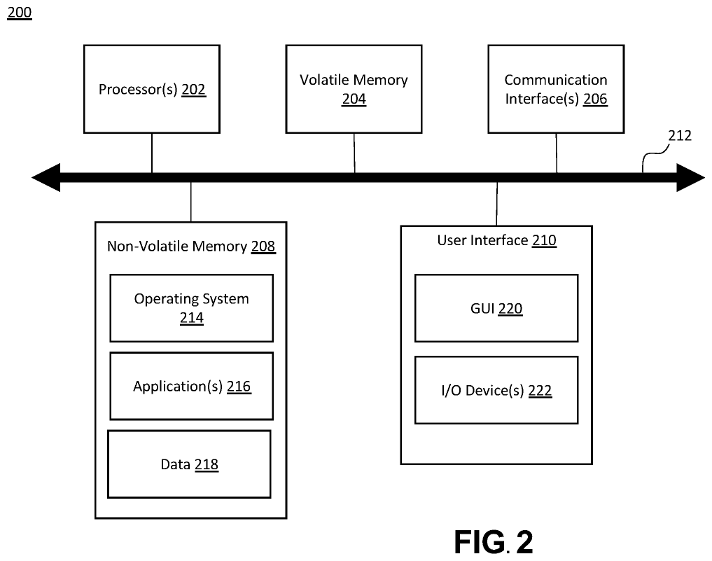

FIG. 2 depicts an illustrative computer system 200 for implementing a method and apparatus for matching partners in an exercise/activity and reserving a location for the exercise/activity according to embodiments of the disclosure. The computer system 200 may include one or more processors 202, volatile memory 204 (e.g., RAM), non-volatile memory 208 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 210, one or more communications interfaces 206, and communication bus 212. User interface 210 may include graphical user interface (GUI) 220 (e.g., a touchscreen, a display, etc.) and one or more input/output (I/O) devices 222 (e.g., a mouse, a keyboard, etc.). Non-volatile memory 208 stores operating system 214, one or more applications 216, and data 218 such that, for example, computer instructions of operating system 214 and/or applications 216 are executed by processor(s) 202 out of volatile memory 204. Data may be entered using an input device of GUI 220 or received from I/O device(s) 222. Various elements of computer 200 may communicate via communication bus 212. Computer system 200 as shown in FIG. 2 is shown merely as an example, as clients, servers and/or appliances and may be implemented by any computing or processing environment and with any type of machine or set of machines that may have suitable hardware and/or software capable of operating as described herein.

Processor(s) 202 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 206 may include one or more interfaces to enable computer system 200 to access a computer network such as a LAN, a WAN, or the Internet through a variety of wired and/or wireless or cellular connections.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be exercise or activity matching apparent to those of ordinary skill in the art without departing from the scope and spirit of the disclosure. The embodiment was chosen and described in order to best explain the principles of the disclosure and the practical exercise or activity matching application and to enable others of ordinary skill in the art to understand the disclosure for various embodiments with various modifications as are suited to the particular use contemplated.

What is claimed is:

1. A method of matching partners for an exercise/activity, the method comprising:
inputting a request for a partner for the exercise/activity by a requestor;
determining if a suitable partner for the exercise/activity exists based on at least one exercise/activity criteria;
notifying the suitable partner that a determination of a possible match for the exercise/activity has been identified;
accepting the match for the exercise/activity by the suitable partner;
determining an exercise/activity location for the requestor and the suitable partner;
confirming acceptance of the exercise/activity location for the requestor and the suitable partner;
determining if the exercise/activity location is available, and reserving the exercise/activity location.

2. The method of claim 1, further including:
the requestor and the suitable partner engage in the exercise/activity; and
entering results of the exercise/activity.

3. The method of claim 1, wherein if the exercise/activity location is not available, identify other exercise/activity locations for the requestor and the suitable partner.

4. The method of claim 1, wherein the at least one exercise/activity criteria includes at least one of: baseball, softball, football, soccer, basketball, volleyball, hockey, dodgeball, and combinations thereof.

5. The method of claim 1, wherein the at least one exercise/activity includes at least one of recreational sport or exercise/activity, such as at least one of golf, tennis, racquetball, squash, cricket, pickleball, hiking, running, walking, frisbee, basketball, cycling, fencing, rowing, horseshoes, cornhole, badminton, bowling, skiing, and combinations thereof.

6. The method of claim 1, further comprising placing a wager on the result of the exercise/activity.

7. The method of claim 6, wherein the wager includes at least one of monetary, credits, gift cards, swag, and items that have value.

8. The method of claim 1, wherein the acceptance of the match for the exercise/activity by the suitable partner includes at least one consideration by at least one of the requestor and the suitable partner.

9. The method of claim 8, wherein the at least one consideration by at least one of the requestor and the suitable partner includes items of value.

10. The method of claim 1, wherein entering results of the exercise/activity includes at least one of handicap integrity, etiquette, sportsmanship, overall experience, exercise/activity location quality, and combinations thereof.

11. The method of claim 1, wherein the requestor and the suitable partner include at least one of: a team, a group, and individual, business, locale, and combinations thereof.

12. A non-transitory computer readable storage medium storing one or more computer programs adapted to cause a processor based system to execute steps comprising of matching partners for an exercise/activity, the method comprising:
inputting a request for a partner for the exercise/activity by a requestor;
determining if a suitable partner for the exercise/activity exists based on at least one exercise/activity criteria;
notifying the suitable partner that a determination of a possible match for the exercise/activity has been identified;
accepting the match for the exercise/activity by the suitable partner;
determining an exercise/activity location for the requestor and the suitable partner;
confirming acceptance of the exercise/activity location for the requestor and the suitable partner;
determining if the exercise/activity location is available, reserving the exercise/activity location; and
recording results of the exercise/activity once the requestor and the suitable partner engage in the exercise/activity.

13. The method of claim 12, wherein if the exercise/activity location is not available, identify other exercise/activity locations for the requestor and the suitable partner.

14. The method of claim 12, wherein the at least one exercise/activity criteria includes at least one of: baseball, softball, football, soccer, basketball, volleyball, hockey, dodgeball, and combinations thereof.

15. The method of claim 12, wherein the at least one exercise/activity includes at least one of a recreational sport or exercise/activity, such as at least one of golf, tennis, racquetball, squash, cricket, pickleball, hiking, running, walking, frisbee, basketball, cycling, fencing, rowing, horseshoes, cornhole, badminton, bowling, skiing, and combinations thereof.

16. The method of claim 12, further comprising placing a wager on the result of the exercise/activity.

17. The method of claim 16, wherein the wager includes at least one of includes monetary, credits, gift cards, swag, and items that have value.

18. The method of claim 12, wherein the acceptance of the match for the exercise/activity by the suitable partner includes at least one consideration by at least one of the requestor and the suitable partner.

19. The method of claim 8, wherein the at least one consideration by at least one of the requestor and the suitable partner includes items of value.

20. The method of claim 12, wherein entering results of the exercise/activity includes at least one of handicap integrity, etiquette, sportsmanship, overall experience, exercise/activity location quality.

21. The method of claim 12, wherein the requestor and the suitable partner include at least one of: a team, a group, and individual, business, exercise/activity location.
